(19) United States
(12) Patent Application Publication
(10) Pub. No.: US 2007/0139316 A1
(43) Pub. Date: Jun. 21, 2007

(54) LED MODULE WITH INTEGRATED CONTROLLER

(75) Inventor: Edward Craig Hyatt, Durham, NC (US)

Correspondence Address: MOORE AND VAN ALLEN PLLC FOR SEMC, P.O. BOX 13706, 430 DAVIS DRIVE, SUITE 500, RESEARCH TRIANGLE PARK, NC, 27709, US

(73) Assignee: SONY ERICSSON MOBILE COMMUNICATIONS AB, Lund (SE)

(21) Appl. No.: 11/306,277

(22) Filed: Dec. 21, 2005

(51) Int. Cl. G09G 3/32

(52) U.S. Cl. 345/82

(57) ABSTRACT

An LED module may include a plurality of LED wafers. Each LED wafer may be capable of emitting light in a different color. The LED module may also include an intelligent controller to control operation of each of the LED wafers. Each of the LED wafers may be integrated with the controller and the LED wafers may be combinable in different combinations to produce light in a multiplicity of different colors and intensities under control of the intelligent controller.

### BACKGROUND OF THE INVENTION

The present invention relates to light emitting diodes (LEDs), and more particularly to a light emitting diode module with an integrated controller.

Color lighting effects, color lighting schemes, themes or the like for communications devices, such as cellular telephones, communicators and other portable communications devices, are becoming important features and add to the marketability and usefulness of such devices. The color lighting effects may involve backlighting, special lighting effects and other lighting associated with displays, keypads or keyboards and other user visible aspects of a communications device. The ability to uniquely control and individualize such color lighting effects, schemes or the like are also becoming important features. Accomplishing such color lighting features with discrete components has considerable challenges, such as cost; space requirements in a device where a small compact size may be important; power consumption; complexity of controlling; routing of control wiring and other design and implementation challenges.

### BRIEF SUMMARY OF THE INVENTION

In accordance with another embodiment of the present invention, an LED module may include a plurality of LED wafers. Each LED wafer may be capable of emitting light in a different color. The LED module may also include an intelligent controller to control operation of each of the LED wafers. Each of the LED wafers may be integrated with the controller and the LED wafers may be combinable in different combinations to produce light in a multiplicity of different selected colors and intensities under control of the intelligent controller. As used herein, LED wafer may mean any type of LED, such as an LED laser or other light emitting device.

In accordance with another embodiment of the present invention, a communications device may include a display and a keypad, keyboard or the like. The communications device may also include an LED module to provide at least one selected color lighting effect for the display and keypad. The LED module may include a plurality of LED wafers. Each LED wafer may be capable of emitting light in a different color. The LED module may also include an intelligent controller to control operation of each of the LED wafers. Each of the LED wafers may be integrated with the controller and the LED wafers may be combinable in different combinations to produce light in a multiplicity of different colors and intensities under control of the intelligent controller.

In accordance with another embodiment of the present invention, a method for applying a color lighting effect to a communications device may include transmitting a signal corresponding to the color lighting effect and decoding a command from the signal. The method may also include setting a brightness level of each of a plurality of LED wafers based on the decoded command and setting a blink duty cycle based on the decoded command. As used herein, color lighting effect may mean a color lighting scheme or schemes, color lighting theme or themes or any arrangement of color lighting or color lighting effects or backlighting that may be applied to features or components of a communications device, such as a display, keypad or keyboard or similar components.

In accordance with another embodiment of the present invention, a computer program product for applying a color lighting effect may include a computer useable medium having computer useable program code embodied therein. The computer useable medium may include computer useable program code configured to transmit a signal corresponding to the color lighting effect. The computer useable medium may also include computer useable program code configured to decode a command from the signal. The computer useable medium may also include computer useable program code configured to set a brightness level of each of a plurality of LED wafers based on the decoded command. The computer useable medium may further include computer useable program code configured to set a blink duty cycle based on the decoded command.

Other aspects and features of the present invention, as defined solely by the claims, will become apparent to those ordinarily skilled in the art upon review of the following non-limited detailed description of the invention in conjunction with the accompanying figures.

### BRIEF DESCRIPTION OF THE SEVERAL VIEWS OF THE DRAWINGS

FIG. 1 is a perspective view of an example of an LED module with an integrated intelligent controller in accordance with an embodiment of the present invention.

FIG. 2 is a block schematic diagram of an exemplary LED module with an integrated controller in accordance with an embodiment of the present invention.

FIG. 3 is an illustration of an example of operation of an LED module to provide a color lighting effect in accordance with an embodiment of the present invention.

FIG. 4 is an example of a state diagram for an LED with an integrated controller in accordance with an embodiment of the present invention.

FIG. 5 is a flow chart of an example of a method for applying a color lighting effect to a communications device or the like in accordance with an embodiment of the present invention.

FIG. 6 is block schematic diagram of an exemplary mobile communications device including an LED module with an integrated controller in accordance with an embodiment of the present invention.

### DETAILED DESCRIPTION OF THE INVENTION

The following detailed description of embodiments refers to the accompanying drawings, which illustrate specific embodiments of the invention. Other embodiments having different structures and operations do not depart from the scope of the present invention.

As will be appreciated by one of skill in the art, the present invention may be embodied as a method, system, or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product on a computer-usable storage medium having computer-usable program code embodied in the medium.

Any suitable computer useable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include some or all of the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission medium such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

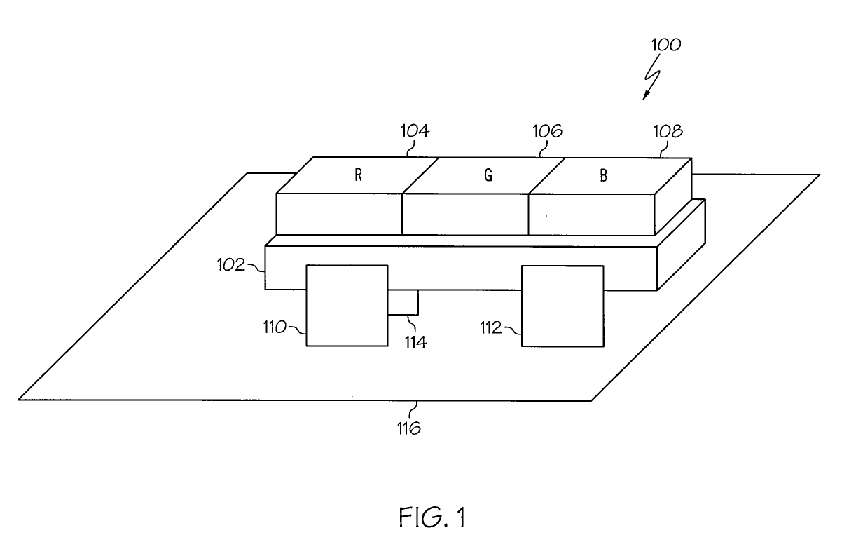

FIG. 1 is a perspective view of an example of an LED module 100 with an integrated intelligent controller 102 in accordance with an embodiment of the present invention. The LED module 100 may be a full-spectrum LED module capable of producing light at least substantially in all visible wavelengths. The LED module 100 may include a plurality of LED wafers, each capable of emitting light in a different color. In the example illustrated in FIG. 1, the LED module 100 may include a red (R) LED wafer 104, a green (G) LED wafer 106, and blue (B) LED wafer 108. LED wafers capable of emitting other colors may also be used depending upon the particular colors or color effects that may be desired. The LED wafers 104-108 may be integrated or integrally formed with the intelligent controller 102. The LED wafers 104-108 may be combinable in different combinations to produce light in a multiplicity of different colors and intensities under control of the intelligent controller 102. Each of the LED wafers 104-108 may be any type of LED, for example an LED laser or the like.

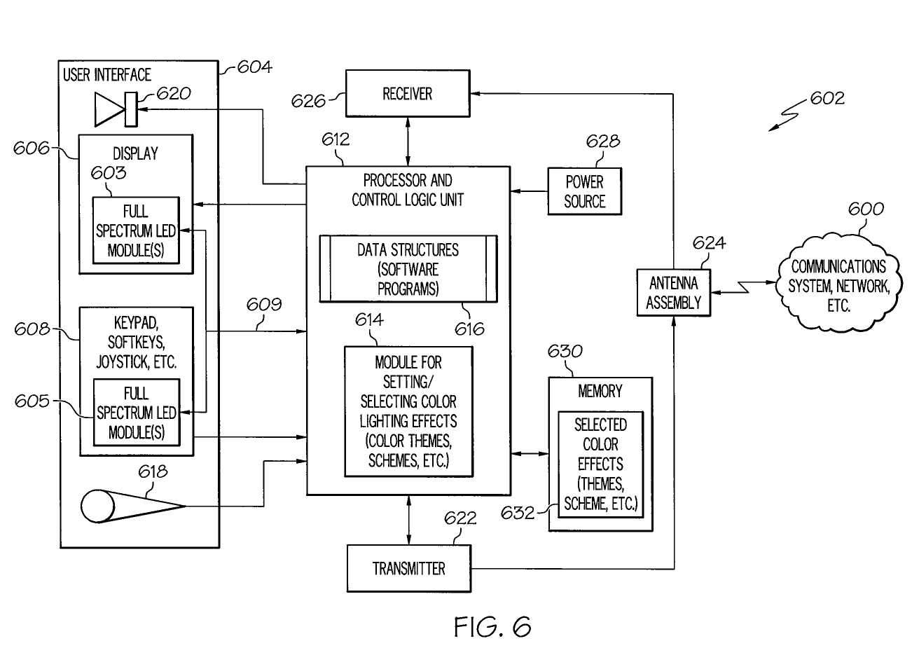

The LED module 100 may include a power pin 110 and a ground pin 112 for supplying power to the module 100 and one or two bus pins 114 connectable to a bus for receiving signals for controlling operation of the LED wafers 104-108 as described in more detail herein to apply selected color effects to a communications device or for other purposes. The module 100 may be mounted to a substrate 116, printed circuit or the like that may form a component of a communications device, such as the mobile communications device 600 illustrated in FIG. 6.

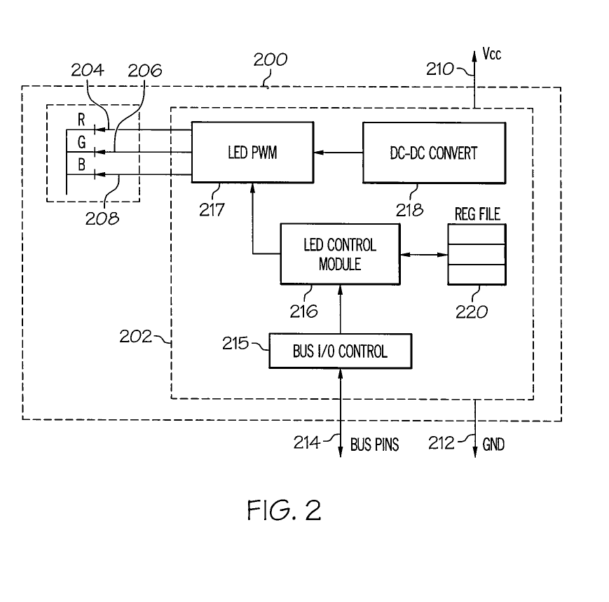

FIG. 2 is a block schematic diagram of an exemplary LED module 200 with an integrated LED controller 202 in accordance with an embodiment of the present invention. The LED module 200 may be a full-spectrum LED module and may be similar to the module 100 illustrated in FIG. 1. The module 200 may include a plurality of LED wafers 204-208. Each LED 204-208 may be capable of emitting light in a different color. In the example illustrated in FIG. 2, the module 200 may include an LED 204 capable of emitting red (R) light, an LED 206 capable of emitting green (G) light, and an LED 208 capable of emitting blue (B) light. Each of the LED wafers 204-208 may be any type of LED or light emitting device, such as an LED laser or the like. The module 200 may also include a power pin 210 for applying a supply voltage (Vcc) to the module 200 and a ground pin 212. The module 200 may also include at least one bus pin 214 to couple the integrated controller 202 to a bus for receiving signals for controlling operation of the module 200.

The integrated controller 202 may include a bus input/output (I/O) control 215 or control module capable of receiving commands or signals over one or two wires, such as a Philips I²C-bus controller (available from Philips Semiconductor, The Netherlands), a Maxim 1-Wire Bus Master (available from Maxim Integrated Products, Inc., Sunnyvale, Calif.) or a similar controller or interface capable of providing a one or two wire bus solution. Philips and I²C-bus are trademarks of Koninklijke Philips Electronics N.V. in the United States, foreign countries or both. Maxim and 1 -Wire are trademarks of Maxim Integrated Products, Inc. in the United States, foreign countries or both. A proprietary bus arrangement may also be defined. The one or two-wire bus solution minimizes and simplifies the routing of control wiring and minimizes space requirements on printed circuit boards or the like for line traces for control wiring routing.

The bus I/O control module 215 may implement whatever standard or proprietary bus may be desired or designed. As described in more detail herein, the integrated controller 202 may respond to commands or signals, such as setting a blink duty cycle, a lighting level for each LED, going into a sleep mode or other operations or functions.

The integrated controller 202 may also include an LED control 216 or control module to control operation of each of the individual LED wafers 204, 206 and 208, such as a brightness level, light intensity or other parameters. The integrated controller 202 may further include an LED pulse width modulator (PWM) circuit 217 or a similar device capable of controlling a level of brightness of each of the individual LED wafers 204-208. The PWM circuit or control 217 may efficiently control the independent brightness of each colored LED wafer 204-208 by varying an on/off duty cycle of each colored LED wafer 204-208. Controlling the individual brightness levels permits generating the entire color and brightness spectrum with different red, green and blue combinations.

The LED module 200 may also include a direct current-to-direct current (DC-DC) converter 218 to step up the available supply voltage (Vcc), if needed, to a level that may be desired to bring the LED wafers 204-208 to full brightness at their full current setting.

The full-spectrum LED module 200 may further include a register file 220. The register file 220 may retain settings, such as individual wafer brightness settings, blink duty cycle and any other non-volatile parameters.

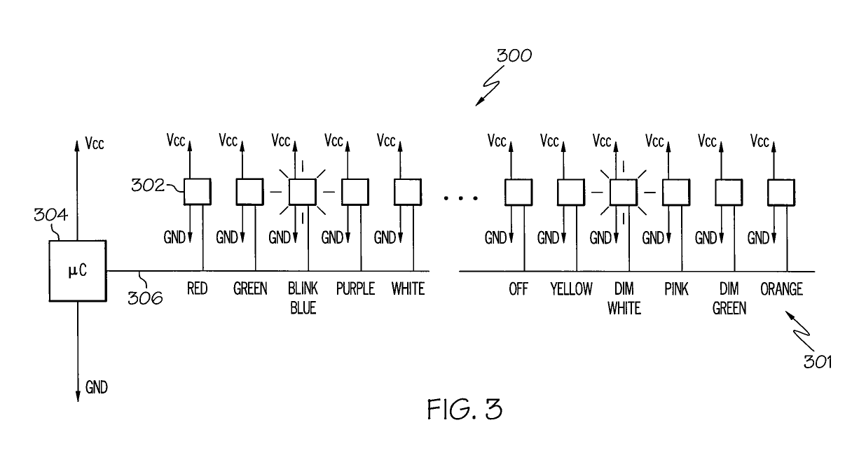

FIG. 3 is an illustration of an example a system 300 to control color lighting effects 301 in a plurality of LED modules 302 in accordance with an embodiment of the present invention. Each LED module 302 may be embodied in the modules 100 and 200 illustrated and described with respect to FIGS. 1 and 2. The system 300 may include a microcontroller 304 or the like and a bus 306 to control operation of the plurality of LED modules 302 to provide different lighting effects 301. The microcontroller 304 may set each of the LED modules 302 to a different color, intensity, or lighting effect. As illustrated in FIG. 3, the lighting effects 301 may include a blinking blue light, a purple light, off or no light output, a white light, yellow, dim white, pink, dim green, orange or the like. The lighting effects 301 may define a selected sequence of lighting effects.

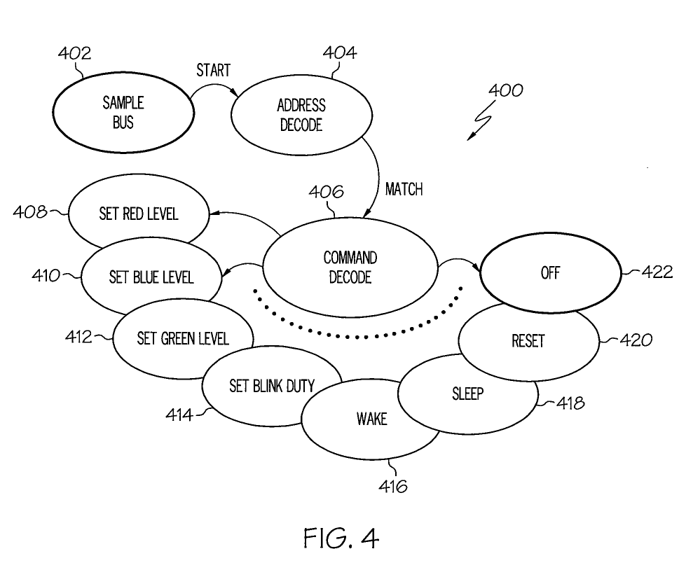

FIG. 4 is an example of a state diagram 400 for a full-spectrum LED with an integrated controller in accordance with an embodiment of the present invention. The state diagram 400 may be applicable to the full-spectrum LED modules 100, 200 and 300 of FIGS. 1, 2 and 3 respectively. In an initial state 402 a bus may be sampled for a signal or command to start a process for color lighting effects or for a color lighting scheme, theme or the like. In state 404, an address may be decoded from the sampled bus signal or command. In state 406, the command may be decoded to determine the precise operations or state to be performed. Examples of the different commands or states may include set red level 408, set blue level 410, set green level 412, set blink duty cycle 414, set wake mode 416, set sleep mode 418, reset LED wafers 420, turn lighting effects or scheme off 422. The state diagram 400 is a simplified model. No error or reset paths are illustrated; although such are commonly known. In essence, a controller, such as controller 202 waits for bus activity. The controller accepts a command destined for it; decodes the command; and initiates execution of the command.

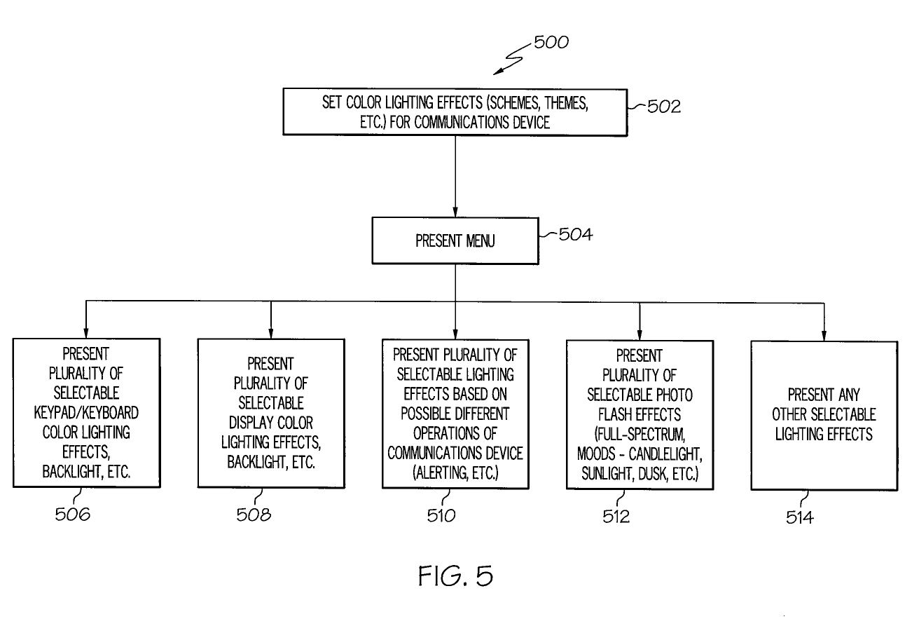

FIG. 5 is a flow chart of an example of a method 500 for applying a color lighting effect or the like to a communications device, such as the device 600 of FIG. 6, in accordance with an embodiment of the present invention. In block 502, a color lighting effects or the like for a communications device may be set. As previously discussed as used herein, color lighting effect may mean a color lighting scheme, color lighting theme or any sort of color lighting arrangement or effects.

In block 504, a menu of different selectable color effects or selectable features to provide different color effects may be presented for selection by a user. The menu may be presented on a display of a communications device. In block 506 a plurality of selectable keypad, keyboard or the like color lighting effects, backlighting or the like may be presented for selection. In block 508, a plurality of selectable display color lighting effects, backlighting or the like may be presented for selection. In block 510, a plurality of selectable lighting effects based on possible different operations of the communications device may be presented. For example a different lighting effect may be selected to alert a user of different events, such as an incoming phone call, a low battery condition, an incoming e-mail, roaming, no service available or other conditions or events. A different alerting color lighting effect may be selected for each of these functions, conditions or events.

Examples of additional color lighting effects available from a full-spectrum LED module may include, in block 512, a plurality of selectable photo flash effects. For example, different photo flash moods may be selected, such as full-spectrum, candlelight, sunlight, dusk or the like.

In block 514 any other selectable lighting affects may be selected. The lighting effects may be selected in association with the keyboard, keypad or other function buttons or devices, display, camera flash or other components that may be used to interface with a communications device and that may enhance the usefulness or aesthetics associated with the communications device.

FIG. 6 is a block schematic diagram of an exemplary system 600 and communications device 602 that may incorporate a full-spectrum LED module 603 or modules in accordance with the present invention. The full-spectrum LED module 603 may be similar to the modules 100 and 200 described with respect to FIGS. 1 and 2, respectively, and may provide different selectable lighting effects similar to those previously discussed. The communications device 602 may be a cordless telephone, cellular telephone, personal digital assistant (PDA), communicator, computer device or the like and is not unique to any particular communication standard, such as Advanced Mobile Phone Service (AMPS), Digital Advanced Mobile Phone Service (D-AMPS), Global System for Mobile Communications (GSM), Code Division Multiple Access (CDMA) or the like. The design of the communications device 602 illustrated in FIG. 6 is for purposes of explaining the present invention and the present invention is not limited to any particular design.

The communications device 602 may include an operator or user interface 604 to facilitate controlling operation of the communications device 602 including initiating and conducting phone calls and other communications. The user interface 604 may include a display 606 to provide visual signals to a subscriber or user as to the status and operation of the communications device 602. The display 606 may be a liquid crystal display (LCD) or the like capable of presenting color images. The display 606 may provide information to a user or operator in the form of images, text, numerals, characters, a graphical user interface (GUI) and the like. The display 606 may present a GUI for the user to enter or select different lighting effects similar to that described with respect to method 500 of FIG. 5. A full-spectrum LED module or modules 603 may be associated with the display 606 to provide different color effects.

The user interface 604 may also include a keypad 608 or keyboard and function keys or buttons including a point device, such as a joystick or the like. The keypad 608, function buttons and joystick may permit the user to communicate commands to the communications device 602 to dial phone numbers, initiate and terminate calls, establish other communications, such as access to the Internet, send and receive email, text messages and the like. The keypad 608, function buttons and joystick may also be used to control other operations of the communications device 602. Another full-spectrum LED module or modules 605 may also be associated with the keypad 608, function buttons and joystick to provide different lighting effects similar to those previously discussed.

The display 606, keypad 608, function buttons and full-spectrum LED module 605 may be coupled to a main processor and control logic unit 612. The LED modules 603 and 605 may be coupled to the main processor and control logic unit 612 by a bus 609. The main processor and control logic unit 612 may be a microprocessor or the like. The main processor and logic unit 612 may include a module 614 for setting/selecting color effects, such as color themes, schemes or the like. Some of the functions and operations described with respect to the LED module 300 (FIG. 3), the state diagram 400 (FIG. 4) and the method 500 (FIG. 5) may be embodied in the module 614. The module 614 for setting/selecting color effects may be embodied in hardware, firmware, software (data structures) or combinations of both. The main processor and logic unit 612 may also include other data structures 616, software programs, computer applications and the like to encode and decode control signals; perform communication procedures and other functions as described herein.

The user interface 604 may also include a microphone 618 and a speaker 620. The microphone 618 may receive audio or acoustic signals from a user or from another acoustic source. The microphone 620 may convert the audio or acoustic signals to electrical signals. The microphone 618 may be connected to the main processor and logic unit 612 wherein the main processor and logic unit 612 may convert the electrical signals to baseband communication signals. The main processor and control logic unit 612 may be connected to a transmitter 622 that may convert baseband signals from the main processor and control logic unit 612 to radio frequency (RF) signals. The transmitter 622 may be connected to an antenna assembly 624 for transmission of the RF signals to the communication medium or system 600.

The antenna assembly 624 may receive RF signals over the air and transfer the RF signals to a receiver 626. The receiver 626 may convert the RF signals to baseband signals. The baseband signals may be applied to the main processor and control logic unit 612 which may convert the baseband signals to electrical signals. The processor and control unit 612 may send the electrical signals to the speaker 620 which may convert the electrical signals to audio signals that can be understood by the user.

A power source 628 may be connected to the main processor and control logic unit 612 to provide power for operation of the communications device 602. The power source 628 may be a rechargeable battery or the like. The communications device 602 may also include at least one data storage device or memory 630. The memory 630 may store different selected color lighting effects 632. The memory 630 may be a computer-readable medium to store computer-executable or computer-usable instructions or data structures, such as the data structures to perform special operations or functions such as those described in accordance with embodiments of the present invention.

The present invention permits a level of control and flexibility that enables applications that may currently be too expensive or difficult to implement with discrete parts. The full-spectrum LED module of the present invention permits the keyboard backlight and the display backlight to be set independently to any desired color as part of a color “theme” or the like. The lighting effects possible with the full-spectrum LED module of the present invention may also permit the keyboard or keypad to cycle through different colors and to do so at a selected frequency. As previously discussed, different “lighting effects” can be applied to provide different visual alerts. Another possible application is providing a full-spectrum photo flash as discussed herein. For example, a red-orange flash can provide a “candle-light” tone to a photograph.

The flowcharts and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems which perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Although specific embodiments have been illustrated and described herein, those of ordinary skill in the art appreciate that any arrangement which is calculated to achieve the same purpose may be substituted for the specific embodiments shown and that the invention has other applications in other environments. This application is intended to cover any adaptations or variations of the present invention. The following claims are in no way intended to limit the scope of the invention to the specific embodiments described herein.

What is claimed is:

1. An LED module, comprising:
a plurality of LED wafers, each LED wafer being capable of emitting light in a different color; and
an intelligent controller to control operation of each of the LED wafers, wherein each of the LED wafers is integrated with the controller and the LED wafers being combinable in different combinations to produce light in a multiplicity of different selected colors and intensities under control of the intelligent controller.

2. The LED module of claim 1, further comprising a power pin, a ground pin and at least one bus pin coupled to the controller.

3. The LED module of claim 2, further comprising a bus control module coupled to the at least one bus pin.

4. The LED module of claim 1, wherein the LED module is surface-mountable on a substrate.

5. The LED module of claim 1, further comprising a register file to retain at least one setting for each of the LED wafers.

6. The LED module of claim 5, wherein the at least one setting for each LED comprises at least one of:
a brightness setting; and
a blink duty cycle.

7. The LED module of claim 1, further comprising a pulse width modulation circuit to independently control a brightness level of each LED.

8. The LED module of claim 1, further comprising a DC-DC converter to provide an appropriate voltage level to each LED.

9. The LED module of claim 1, wherein the plurality of LED wafers comprise an LED wafer capable of emitting red light, an LED wafer capable of emitting green light, and an LED wafer capable of emitting blue light.

10. A communications device, comprising:
a display;
a keypad or keyboard; and
an LED module to provide at least one selected color lighting effect for the display and keypad, wherein the LED module includes:
a plurality of LED wafers, each LED wafer capable of emitting light in a different color, and
an intelligent controller to control operation of each of the LED wafers, wherein each of the LED wafers is integrated with the controller and the LED wafers being combinable in different combinations to produce light in a multiplicity of different colors and intensities under control of the intelligent controller.

11. The communications device of claim 10, further comprising a menu of preset color themes presentable to a user for selection.

12. The communications device of claim 11, wherein the preset color themes comprise:
a plurality of selectable keypad or keyboard color lighting effects and backlights;
a plurality of selectable display color lighting effects and backlights;
a plurality of selectable lighting effects based on different operations of the communications device; and
a plurality of selectable photo flash effects.

13. The communications device of claim 10, wherein the LED module further comprises a register file to retain at least one setting for each of the LED wafers.

14. The communications device of claim 10, wherein the LED module further comprises a pulse width modulation circuit to independently control a brightness level of each LED.

15. A method for applying a color lighting effect to a communications device, comprising:
transmitting a signal corresponding to the color lighting effect;
decoding a command from the signal;
setting a brightness level of each of a plurality of LED wafers based on the decoded command; and
setting a blink duty cycle based on the decoded command.

16. The method of claim 15, further comprising controlling the brightness level of each LED.

17. The method of claim 15, further comprising controlling the brightness level of each LED by applying pulse code modulation.

18. The method of claim 15, further comprising presenting a menu of preset color lighting effects for selection.

19. The method of claim 15, further comprising at least one of:
presenting a plurality of selectable keypad or keyboard color lighting effects and backlights;
presenting a plurality of selectable display color lighting effects and backlights;
presenting a plurality of selectable lighting effects based on different operations of the communications device; and
presenting a plurality of selectable photo flash effects.

20. A computer program product for applying a color lighting effect, the computer program product comprising:
a computer useable medium having computer useable program code embodied therein, the computer useable medium comprising:
computer useable program code configured to transmit a signal corresponding to the color lighting effects;
computer useable program code configured to decode a command from the signal;
computer useable program code configured to set a brightness level of each of a plurality of LED wafers based on the decoded command; and
computer useable program code configured to set a blink duty cycle based on the decoded command.

21. The computer program product of claim 20, further comprising computer useable program code configured to control the brightness level of each LED.

22. The computer program product of claim 20, further comprising computer useable program code configured to control the brightness level of each LED by applying pulse code modulation.

23. The computer program product of claim 20, further comprising computer useable program code configured to present a menu of preset color lighting effects for selection.

24. The computer program product of claim 20, further comprising computer useable program code configured to at least one of:
present a plurality of selectable keypad or keyboard color lighting effects and backlights;
present a plurality of selectable display color lighting and backlights;
present a plurality of selectable lighting effects based on different operations of the communications device; and
present a plurality of selectable photo flash effects.
